(19) United States
(12) Patent Application Publication
(10) Pub. No.: US 2024/0288347 A1
(43) Pub. Date: Aug. 29, 2024

(54) DEVICE FOR MANAGING SAMPLES IN SAMPLE CONTAINERS UNDER VACUUM

(71) Applicant: Andreas Hettich GmbH & Co. KG, Tuttlingen (DE)

(72) Inventor: Ulrich MASSING, Merzhausen (DE)

(21) Appl. No.: 18/573,433

(22) PCT Filed: Jun. 24, 2022
(86) PCT No.: PCT/EP2022/067414

§ 371 Date: Dec. 21, 2023

(30) Foreign Application Priority Data
Jun. 24, 2021 (DE) 10 2021 116 408.7

(51) Int. Cl. G01N 1/40

(52) U.S. Cl. CPC G01N 1/4077; G01N 1/4022; G01N 2001/4027

(57) ABSTRACT

A device for treating samples in sample containers under vacuum comprises a housing, a vacuum chamber in the housing and interacting with a vacuum pump, a cover via which the vacuum chamber is closed in vacuum-tight manner and opened to load and unload sample containers, a sample holder with base surface and plurality of sample container receiving areas. A sample holder axis runs perpendicularly to the base surface, a drive unit mounted in the vacuum chamber drives the sample holder about a longitudinal axis of the vacuum chamber, and a drive mechanism outside of the vacuum chamber is drivingly coupled to the drive unit. The drive unit is connected to the sample holder via a holder bar, the sample holder axis is a central axis of the holder bar and movable in wobbling manner over specified acute holder angle (B) relative to the longitudinal axis of the vacuum chamber.

The invention relates to a device for treating samples in sample containers under vacuum, of the type specified in the preamble of claim 1, and to a method for treating samples.

Devices for treating samples in sample containers under vacuum already known in the art are used for removing liquids from biological, organic or inorganic samples in sample containers by evaporation. The Hettich Vortex Vacuum Concentrator, for example, is a generic device of this type that performs a shaking motion during treatment. These devices are also referred to as vacuum shakers.

This generic device has a vacuum-tight vessel with a shaker unit mounted in it which is provided with sample container holders intended to accommodate sample containers with samples to be shaken under vacuum. Using an appropriate seal, the vessel can be sealed vacuum-tight with a cover. The vessel is evacuated for the shaking motion until the desired negative pressure is set. To ensure a vacuum-tight seal of the vessel containing the shaker, the shaker is magnetically coupled to a motor outside the vessel via a magnetic coupling, for example, in order to drive the shaker in the vessel. The vessel can also be equipped with one or plural heater(s) to control the temperature of the shaker, of the sample containers and of the samples contained in them. Among other things, heat emitters are known, such as light with a high IR component, which radiate through a transparent cover into the vacuum chamber containing the samples, or which cause heating of the walls or the base of the vacuum chamber.

These devices are also known to include temperature-controlled sample container receptacles, which transfer their heat mainly through direct contact with the sample containers.

The samples usually consist of liquids in which solids are dissolved and/or dispersed. The liquids can be volatile or semi-volatile organic solvents, water or a mixture of the above, which are vaporized in a vacuum. After filling the sample containers, such as test tubes or plastic vials, with the samples, the sample containers are placed in the sample container receptacle of the vacuum shaker unit, the shaking process is started and the desired vacuum is created inside the vessel. The vessel is continuously evacuated with a vacuum pump in order to remove the evaporated liquid from the vessel and maintain the desired vacuum despite the evaporation. The solvents and/or water are removed from the vessel via a connection on the vessel, by means of a vacuum pump. To prevent the solvent from damaging the vacuum pump, for example, a cold trap can be provided between the vacuum pump and the vessel. The vacuum to be applied is adapted to the liquids to be vaporized and it can also be further adjusted during the process, if required.

Evaporating the liquids under vacuum using this device has the advantage that the vacuum reduces the boiling temperature of the liquids. This means that the liquid evaporates at a lower temperature, so that the biological, organic or inorganic samples are not at all thermally affected, or at least to a lesser extent. Moreover, the liquids evaporate more quickly. The liquid movement generated by the shaking motion in the sample containers increases the surface area of the sample, which speeds up evaporation.

Moreover, the sample is continuously mixed by the shaking motion. This efficiently compensates for temperature differences in the sample, which can be caused, for example, by heat input from the sample container receptacle, or by cooling of the sample surface due to evaporative cooling. This makes the evaporation process easier to control, and also makes it more efficient in the event of cooling by evaporative cooling. Local cooling of the sample on its surface due to what is called evaporative cooling is thus reduced. In addition, a uniform sample temperature is achieved very quickly in this way, even if the sample containers are arranged in a heating block and/or irradiated by a heat source. The rapid distribution of heat throughout the entire volume of liquid also ensures better overall heat transfer into the sample.

The shaking motion also prevents what is called clod formation on the cool surface of samples due to the precipitation of previously dissolved ingredients, in that it evenly distributes the precipitated substances in the sample container. However, precipitation of substances is also diminished or even prevented by reducing the cooling of certain areas.

Furthermore, the shaking motion counteracts the so-called overfoaming of the samples (boiling delay). Such foaming often occurs when the sample has been heated to boiling temperature or close to boiling temperature, especially if there are undissolved substances in the liquid, or if dissolved substances begin to precipitate or crystallize above a certain concentration and in particular in connection with local cooling. These effects are reduced or delayed by the uniform temperature and the uniform distribution of the dissolved substances in the sample achieved as a result of the shaking motion.

The advantage of using this prior art vacuum shaker is that an orbital motion, a so-called vortex motion, of the liquid can be achieved through the shaking process, which increases the surface area of the sample in the sample vessel, which in turn increases the evaporation rate.

Another technical advantage of this prior art vacuum shaker is that, in contrast to a vacuum centrifuge, in which the sample container receptacles are restricted to being arranged in a circle around the rotor axis or, if necessary, several circles around the rotor axis, sample container holders can be provided over the entire base area of the shaker unit, and these can be loaded with sample containers containing samples. For a vacuum chamber of the same geometry, this allows a higher number of sample containers. In addition, sample vessels of different geometries can easily be placed in the vacuum shaker unit at the same time. In contrast to a vacuum centrifuge, in which the masses of the samples need to be balanced due to the imbalance problem, it is also possible to treat sample containers with different quantities of samples at the same time.

Disadvantageous about the prior art vacuum shakers is that it is difficult to set the correct frequency of the shaking motion for achieving an undisturbed orbital motion of the sample surface. Less than optimal orbital motion will reduce the achievable surface enlargement and prolong the evaporation process. Setting the optimum frequency of the shaking motion is particularly difficult with sample containers having a small diameter, such as plastic vials, which are often used in the field of biochemistry, especially with so-called microtiter plates. For vessels having a small diameter, a higher frequency needs to be selected in order to induce an orbital motion of the liquid sample in the sample container. This makes it even more difficult to set the exact frequency required because the sample containers have to be observed for the correct setting, which is not possible in most cases. It is almost impossible to set the precise frequency of the shaking motion if the sample containers placed in the vacuum shaker have different diameters and/or are differently filled, which is actually one of the advantages of this type of vacuum evaporation.

The process of setting the frequency of the shaking motion is also problematic due to the continuous change in the physical properties of the sample during evaporation. For example, an increase in the concentration of the dissolved ingredients leads to an increase in the viscosity of the sample. Dispersed ingredients can also change the flow properties of the sample. These changes in the sample require constant adjustment of the frequency of the shaking motion, which is not easy to realize in practice.

It is known that positioning a rotating sample holder at an angle, for example in rotary evaporators, will increase the surface area in order to improve vacuum evaporation. As a result, liquid samples in the sample container will flow continuously in one direction due to gravity, whereby an additional part of the inside of the sample container is continuously wetted with the liquid. In addition to the increase in surface area due to the inclined position of the sample containers, this further increases the liquid surface available for vaporization. This approach is a simple way of ensuring optimum and reproducible evaporation in the sample container, whereby the achievable surface enlargement is largely independent both of the rotational speed of the sample containers and of the change in viscosity of the sample. In a rotary evaporator, the vacuum chamber is also the sample container.

The disadvantage of this is that special vacuum-proof sample containers, such as sample flasks, are required. Sample containers of different shapes as well as those made of plastic, for example, are not suitable.

Another problem is that usually only one sample container can be used at a time, which is connected to the rotary evaporator in a vacuum-tight manner via a so-called ground joint. Simultaneous evaporation of different samples is therefore time-consuming and only possible if a so-called spinner is used. This is a device that is connected to the rotary evaporator via a ground joint on one side, but has several smaller ground joints on the other side, to which smaller vacuum-tight containers can be attached, which in turn must have a ground joint themselves. For this reason, simple containers cannot be used. Moreover, in order to achieve vacuum tightness, all ground joints have to be utilized, so a flexible number of containers cannot be used here either.

Due to the rotation of the entire vacuum chamber, for example of a vacuum flask, it is also necessary for the latter to be connected to a rotating vacuum tube, which is made to rotate longitudinally by a drive unit and connects the vacuum chamber to a cooler unit and to the collecting flask for the solvents. The vacuum tube must therefore rotate in a tight-fitting sleeve to seal the vacuum against the atmospheric pressure prevailing outside the device. Owing to the rotation of the vacuum tube, this is not always possible without any problems; a high vacuum in the sample container cannot usually be generated by means of rotary evaporators. Under optimum conditions, a vacuum pressure in the single-digit mbar range is usually achieved.

It is the object of the invention, therefore, to further develop a device of the type specified in the preamble of claim 1 in such a way that the evaporation process during treatment of the samples under vacuum is improved without additional temperature increase, whilst avoiding the above mentioned disadvantages.

This object is accomplished for a device according to the invention by the characterizing features of claim 1 in conjunction with the features of its preamble.

The dependent claims relate to advantageous further embodiments of the invention.

The invention is based on the realization that this principle of surface enlargement in a vacuum chamber is carried out simultaneously and very easily in several separate containers.

According to the invention, the device for treating samples in sample containers under vacuum comprises a housing and a vacuum chamber which is arranged in the housing and which interacts with a vacuum pump. The vacuum chamber can be closed vacuum-tight via a cover and can be opened for loading and unloading the sample containers. Moreover, a sample holder with a base area and several sample container receptacles is provided for receiving sample containers. A sample holder axis runs perpendicular to a base surface of the sample holder. Furthermore, a drive unit mounted in the vacuum chamber is provided, which is connected to the sample holder and drives the sample holder around the sample holder axis. A drive mechanism is arranged outside the vacuum chamber, which is drivingly coupled to the drive unit. According to the invention, the drive unit is connected to the sample holder via a holder bar. The sample holder axis constitutes the central axis of the holder bar. The sample holder axis of the sample holder is designed to wobble over the range of a specified acute holder angle with respect to the longitudinal axis of the vacuum chamber.

By setting the holder angle, an optimum surface enlargement can be set in the sample containers, thereby accelerating the vacuum evaporation of liquids. Due to the wobbling motion around the longitudinal axis, the side walls of the sample containers are continuously wetted with liquid over a large area.

The base area of the sample holder is the projection of the outer circumference of the sample holder onto a plane.

When the sample holder is moved around the sample holder axis by the drive mechanism, this induces a relative orbital motion in the liquid sample in relation to the sample container due to the acting force of gravity, with the type of orbital motion of the liquid sample—in a first approximation—not being dependent on the speed of the movement. The relative orbital motions of the sample generated in this way causes further parts of the inner surface of the sample container to be wetted, which in turn leads to an increase in the surface area that can be evaporated. The greater the angle of the sample holder, and thus of the sample containers, to the vertical axis, the greater the increase in surface area. This applies to the surface enlargement at rest, and to the surface enlargement due to the relative orbital motion.

Preferably, the holder angle is in a range of between (and including) 8° and 85° to the vertical axis. In particular, the holder angle is 40°. If the angle is too small, the orbital movement is not sufficient to bring about a significant increase in surface area. If the angle is too large, the orbital motion will not result in wetting of the surface, but a large amount of liquid will flow over the surface, so that there is no longer an advantage in evaporation.

Preferably, the sample holder axis and the holder bar are mounted for rotation about the longitudinal axis of the vacuum chamber, with the longitudinal axis forming a wobble axis. This results in a wobbling motion of the sample holder about the longitudinal axis.

In another advantageous embodiment of the invention, the sample holder receptacles each have a mounting axis, which axes are designed as longitudinal axes. The mounting axes of the sample container receptacles are aligned parallel to each other. This ensures that all samples in the sample containers are treated in the same way in the sample container receptacles. However, it is also conceivable for the mounting axis to be aligned differently, for example for different diameters of sample container receptacles for different sizes of sample containers or for different geometries of sample containers.

In order to achieve simple angular adjustment of the mounting axes of the sample containers via the sample holder axis, the sample holder axis is aligned parallel to the mounting axes of all sample container receptacles.

Preferably, the sample holder axis is parallel to the mounting axes of all sample container receptacles.

In another advantageous embodiment of the invention, a drive shaft cooperating with the drive unit is provided, which generates the wobbling motion of the sample holder about the longitudinal axis via the holder bar.

Preferably, the drive shaft cooperates with a gear unit for transmitting the rotational movement.

Preferably, the gear unit has a first gear wheel connected to the drive shaft and a second gear wheel connected to the sample holder, with the first and second gear wheels meshing with one another in a drive-locking manner. The step-up ratio or reduction ratio can be set via the diameter of the respective gear wheels. In this case, the holder bar can be connected to the second gear wheel.

In order to allow for simple adjustment of the moving speed of the sample in the sample container, the gear unit forms a step-up gear or a reduction gear.

In order to guarantee a targeted wobbling motion at all times, the holder bar is mounted on a joint that is spaced apart from the sample holder and the drive unit. The joint can be arranged in a joint holder connected to the vacuum chamber.

In another advantageous embodiment of the invention, the drive mechanism and the drive unit are coupled to one another via a contactless coupling. This eliminates the need for complex seals for through openings in the vacuum chamber used for driving the drive unit.

To facilitate evaporation in the vacuum chamber, a device for heating the vacuum chamber is provided. This can be an IR emitter, for example, which is directed at the vacuum chamber, particularly from above. Additionally or alternatively, heaters can also be installed in the floor or walls of the vacuum chamber. In a particular embodiment of the invention, a heater can also be built into the sample holder of the wobbling device, because this sample holder does not change its relative angular position in the xy plane and can therefore be easily supplied with energy via a flexible cable.

In one embodiment of the invention, a set of different types of sample holders is provided, one sample holder in each case being detachably connectable to the drive unit. This makes it possible to connect different sample containers to the sample holder, but also to provide different longitudinal axes for the sample container receptacles.

In addition or as an alternative, a set of different drive units may also be provided, in which one drive unit each can be detachably connected to the sample container in the vacuum chamber for different movements of the samples in the sample containers during the treatment of samples, and can be coupled to the drive mechanism. This makes it possible, for example, to realize a tumbling motion of the sample holder in the vacuum chamber.

In one aspect of the invention, in a method for operating a device for treating samples in sample containers under vacuum, as just described, a continuous movement of the sample holder about a longitudinal axis is carried out during treatment of the samples.

Preferably, the movement is executed as a wobbling motion of the sample holder around the longitudinal axis.

During a wobbling motion of the sample holder, the samples flow continuously in one direction on the inner surface of the sample container. This results in an orbital movement of the sample relative to the sample container.

The drive unit preferably drives the sample holder around the longitudinal axis at a wobbling frequency of between 0.5 rpm and 150 rpm.

In another aspect of the invention, in the method for removing liquids from samples in sample containers by evaporation by means of a device for treating samples in sample containers under vacuum, the sample containers are moved in such a way that the samples flow continuously in one direction on the inner surface of the sample container. This is preferably carried out using a device as described above.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

FIG. 1 is a perspective view, taken from above, of the front of a device for treating samples in sample containers under vacuum according to the invention, with its cover closed;

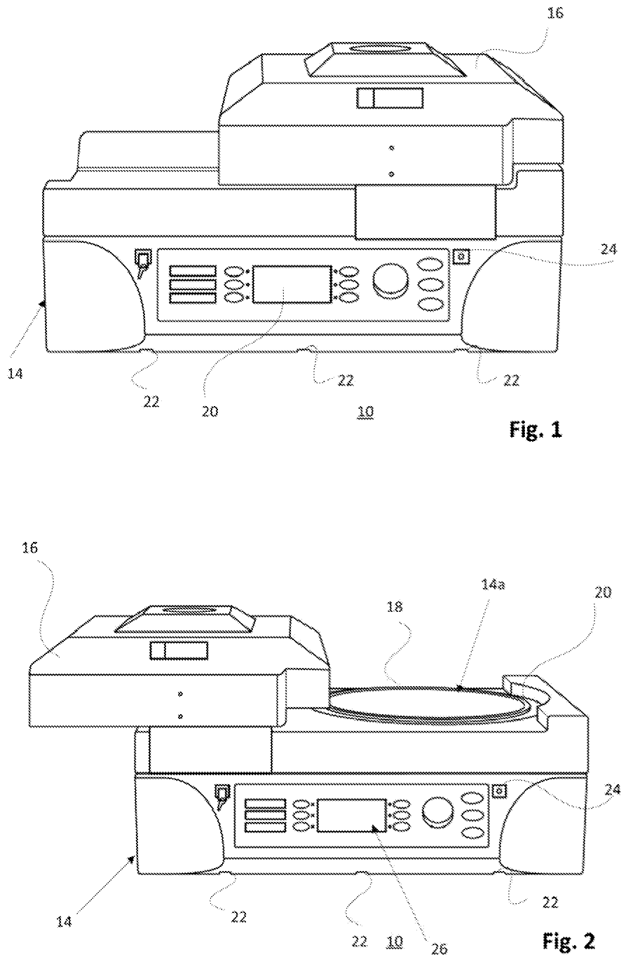

FIG. 2 is a perspective view, taken from above, of the front of a device for treating samples in sample containers under vacuum according to the invention, with its cover open;

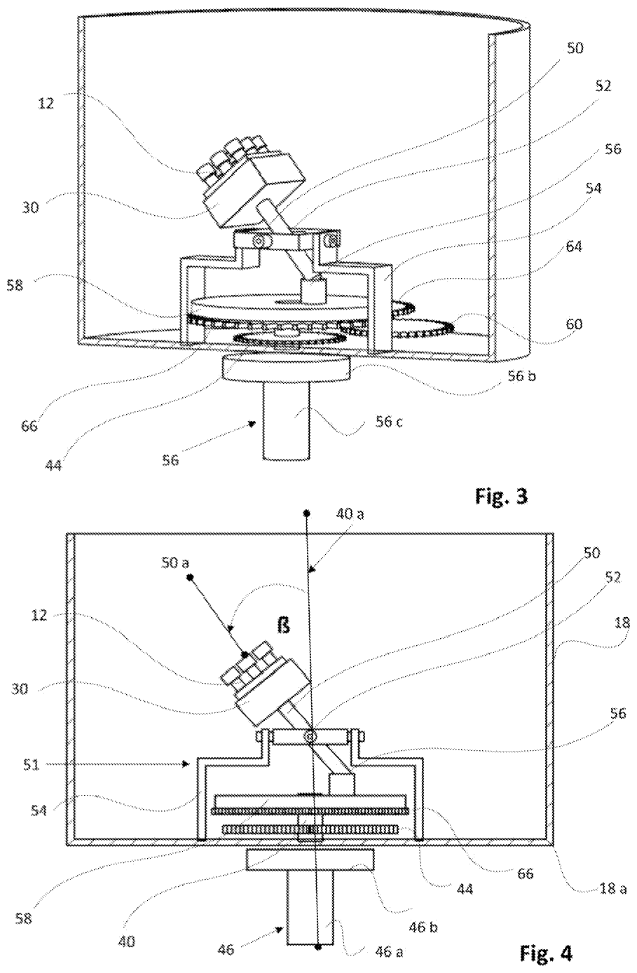

FIG. 3 is a schematic perspective partial sectional view of the invention;

FIG. 4 is another schematic view from the front with partial section, of FIG. 3;

FIG. 5 is a schematic side view with partial section, of FIG. 3;

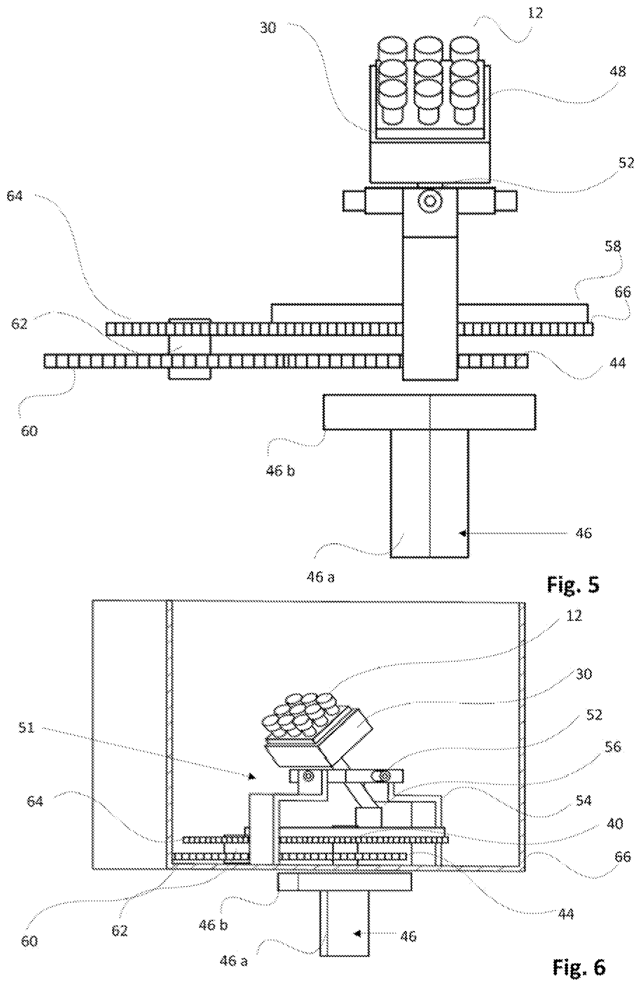

FIG. 6 is another schematic side view with partial section, of FIG. 3;

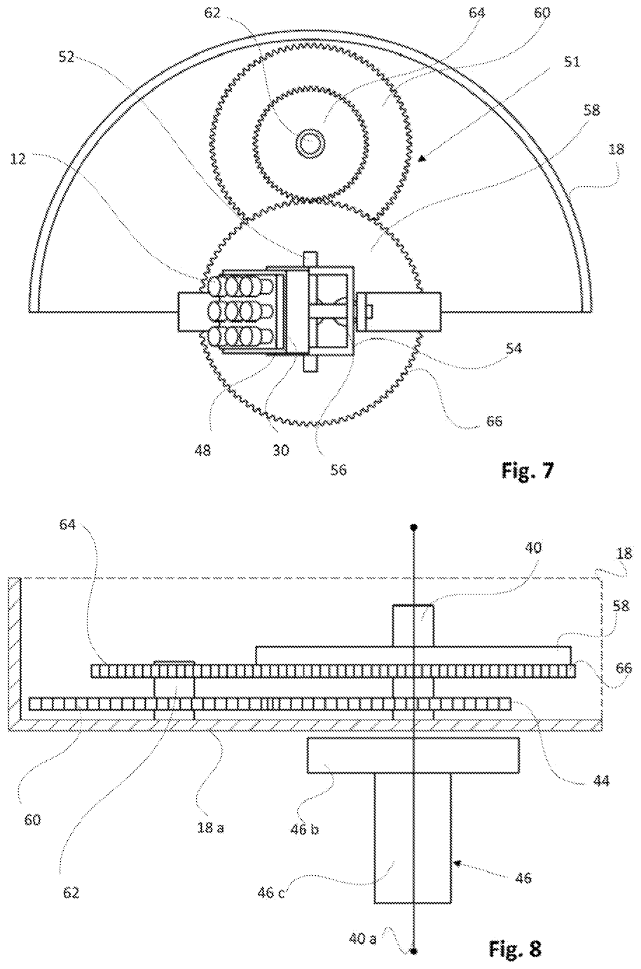

FIG. 7 is another schematic view from above, of FIG. 3, and

FIG. 8 is a schematic detailed view of a gear unit and the drive mechanism, of FIG. 3.

The Figures are views of a device 10 for treating samples in sample containers 12 under vacuum according to the invention. The device 10 comprises a housing 14 with a cover 16, which can be moved on the housing 14 between an open position, see FIG. 2, and a closed position, see FIG. 1, by means of a closing and opening mechanism (not shown in detail here). The cover 16 closes a vacuum chamber 14a disposed in the housing 14 in a vacuum-tight manner. When the device 10 is open, it is released sufficiently to allow loading and unloading with sample containers 12.

A safety vessel 18 is arranged in the housing 14, which has an opening in the base 18a, which opening interacts in a known manner with a vacuum pump via vacuum lines. An exhaust air duct is connected to the vacuum pump and discharges into the environment. The safety vessel 18 and the cover 16 delimit the vacuum chamber 14a, in which the samples contained in sample containers 12 are treated under vacuum.

The vacuum pump can be arranged outside the housing 14 or inside the housing 14. As these types of device with a vacuum pump are basically known, they will not be discussed in detail here.

A seal 20 is disposed in the upper area of the safety vessel 18, which seal interacts with a seal (not shown here) in the cover 16, thus ensuring a vacuum is created inside the safety vessel 18, if required, when the cover 16 is closed, by the cover 16 closing the vacuum chamber 14a in a vacuum-tight manner.

The housing 14 is mounted on feet 22, which are provided underneath the housing 14. The device 10 is switched on and off via a mains switch 24. The operating mode of the device 10 is set via a touch display 26.

FIGS. 3 to 8 show the device according to the invention in which the samples in the sample containers 12 are moved by means of a wobbling motion during treatment.

In the safety vessel 18, the sample holder 30 is located which is provided with a holder bar 50 which extends vertically downwards from the sample holder 30, i.e. from its base surface, and which is drivingly connected to a drive unit 51.

The holder bar 50 is arranged concentrically to a holder axis 50a running perpendicular to the base area of the sample holder 30. A joint 52 is provided approximately in the center of the holder bar 50, which enables rotational movement of the sample holder 30 with the holder bar 50 about two horizontal axes aligned at right angles to one another. The joint 52 is connected to a joint holder 54, which is arranged concentrically to the drive axis 40a and is connected to the base 18a of the safety vessel 18. The free end of the holder axis 50 is connected to a drive pulley 58 via a ball joint 56, which ball joint 56—and thus the one free end of the holder bar 50—is arranged radially offset to the drive axis 40a.

The drive pulley 44 is part of a reduction gear. The drive pulley 44 is arranged in the area of the base 18a, but is freely rotatable relative to the drive shaft 40. A magnetizable rod, which is not shown in detail here, is integrated into the drive pulley 44 and extends transversely to the drive shaft 40. The drive shaft 40 is mounted for rotation about the longitudinal axis 40a on the base 18a in the safety vessel 18. The magnetizable rod runs on either side of the longitudinal axis 40a and is arranged symmetrically to it.

The drive pulley 44 drives a gear wheel 60. A gear wheel 64 concentric to a shaft 62 and firmly connected to it is driven by a shaft 62 that is firmly connected and arranged concentrically to the gear wheel 60, which shaft 62 is mounted for rotation on the base 18a of the safety vessel 18. This gear wheel 64 in turn drives a gear wheel 66 which is firmly connected to both the drive shaft 40 and to the drive pulley 58. The drive pulley 58, the gear wheel 66 and the drive shaft 40 are arranged concentrically to the longitudinal axis 40a.

The drive shaft 40 is driven by magnetic force coupling. For this purpose, the electric drive 46 is provided outside the safety vessel 18, and thus outside the vacuum chamber 14a, underneath the base 18a and concentrically to a longitudinal axis 40a. The electric drive 46 is used to drive the drive pulley 44, which is designed as a gear wheel, with the integrated magnetizable rod without contact via corresponding magnetic fields. For this purpose, the electric drive 46 also includes the motor 46a and the rod-shaped magnet 46b driven by the motor 46a and disposed in a magnetic disc 46b. The drive pulley 44 is driven by the electric drive 46 via magnetic force coupling, which causes the gear wheel 60, the shaft 62, the gear wheel 64 and, through it, the gear wheel 66 and thus the drive shaft 40 with the drive pulley 58 to also be driven. The end of the holder bar 50 is rotated via the drive pulley 58, and the sample holder 30, which is firmly connected to the holder bar 50, performs a wobbling movement, i.e. the sample holder 30 wobbles about a wobble axis that corresponds to the longitudinal axis 40a.

In a final wobbling position, the holding axis 50a and thus the holder bar 50 are at a maximum angle β of 45° to the longitudinal axis 40a, see FIG. 4. The holder axis 34 and the longitudinal axis 40a, which constitutes the wobble axis, form this angle β with each other, because the longitudinal axis 40a is aligned vertically. As seen in the side view of FIG. 4, the sample holder 30 wobbles over this angle in operation.

It is also conceivable for the holder bar 50 to form an angle of between 8° and 85° to the longitudinal axis 40a.

The sample holder 30 is of rectangular design (while other geometries are also possible) and has a plurality of sample container receptacles 48, into each of which a sample container 12 with a sample to be treated can be inserted. The sample container receptacles 48 are formed by recesses in the sample holder 30, with the longitudinal axis of the recesses being perpendicular to the base surface of the sample holder 30 and thus parallel to the holder axis 50a. Thus, the sample containers 12 all have their longitudinal axes aligned parallel to one another in the sample holder 30. The longitudinal axes of the sample containers 12 and of the sample container receptacles 48 are aligned parallel to the holder axis 50a.

The holder axis 50a extends vertically and centrally to the base surface of the sample holder 30.

During treatment of the liquid sample with the device 10 according to the invention, liquids are removed from biological, organic or inorganic samples in sample containers 12 by evaporation. The vacuum reduces the boiling temperature of the liquids. This means that the liquid evaporates at a lower temperature, so that the biological, organic or inorganic samples are not affected at all, or at least to a lesser extent. Moreover, the liquids evaporate more quickly.

The samples normally consist of liquids in which solids are dissolved and/or dispersed. The liquids can be volatile or semi-volatile organic solvents, water or a mixture of the above, which are vaporized in a vacuum. After filling the sample containers 12, such as test tubes, plastic vials, microtiter plates, Erlenmeyer flasks, beakers, round bottom flasks, etc., with the samples, these are placed in the sample holder 30 of the device 10. The tumbling motion is started and the desired vacuum is created in the vacuum chamber 14a. The safety vessel 18 is continuously evacuated with the vacuum pump in order to remove the evaporated liquid from the vacuum chamber 14a and to maintain the desired vacuum despite the evaporation. During movement of the sample holder 20, the solvents and/or the water evaporate, which is then removed from the vacuum chamber 14a via the opening in the base 18a of the safety vessel 18 leading to the vacuum chamber 14a, by means of the vacuum pump 26. The vacuum to be applied is adapted to the liquids to be vaporized and can also be further adjusted during the process, if required.

The device 10 can also be equipped with a heater to control the temperature of the rotor 12 and of the sample containers 12 with the sample arranged inside them. Among other things, heat emitters are known, such as light with a high IR component, which radiate into the vacuum chamber 14a containing the samples. For reasons of clarity, this heater is not shown in the drawings.

The invention is characterized by the fact that, during the tumbling motion, the sample containers 12 with the liquid samples in the sample containers 12 continuously flow in one direction due to gravity. As a result, an additional part of the inside of the sample container 12 is continuously wetted with the liquid sample. This further increases the available liquid surface area. This approach is a simple way of ensuring optimum and reproducible evaporation in the sample container 12. The achievable surface enlargement is largely independent of the tumbling speed of the sample containers 12 and of the change in viscosity of the sample. The surface enlargement depends on the angle β and thus on the wobbling movement of the sample containers 12.

When the sample holder 30 is moved by the drive mechanism about the longitudinal axis 40a, which serves as a wobble axis, a relative orbital motion is induced in the liquid sample in relation to the sample container 12 due to the acting force of gravity. The relative orbital motion of the sample generated in this way causes further parts of the inner surface of the sample container 12 to be wetted, which in turn leads to an increase in the surface area that can be evaporated. The greater the angle β of the sample holder 30 and thus of the sample containers 12 to the vertical, the greater the increase in surface area. This applies to the surface enlargement at rest and to the surface enlargement due to the relative orbital motion.

### LIST OF REFERENCE SIGNS

10 device
12 sample container
14 housing
14a vacuum chamber
16 cover
18 safety vessel
18a base of safety vessel 18
20 seal
34 feet of housing 10
24 mains switch
26 touch display
28 support
30 sample holder
40 drive shaft
40a longitudinal axis
44 drive pulley
46 electric drive
46a motor
46b magnetic disk
48 sample container receptacle
50 holder bar
50a holder axis
51 drive unit
52 joint
54 joint holder
56 ball joint
58 drive pulley
60 gear wheel
62 shaft
64 gear wheel connected to shaft 62
66 gear wheel connected to drive shaft 40
β holder angle, angle of holder axis 50a to a vertical

1-22. (canceled)

23. A device for treating samples in sample containers under vacuum, comprising:
a vacuum chamber (14a), wherein the vacuum chamber (14a) is arranged in a housing (14) and interacts with a vacuum pump,
a cover (16), wherein the vacuum chamber (14a) is closed in a vacuum-tight manner and opened in order to load and unload sample containers (12) via the cover (16),
a sample holder (30), wherein the sample holder (3) comprises a base surface and a plurality of sample container receptacles (48) for receiving the sample containers (12), a sample holder axis (50a) runs perpendicular to the base surface of the sample holder (30), a drive unit (51) is mounted in the vacuum chamber (14a) and drives the sample holder (30) about a longitudinal axis (40a) of the vacuum chamber (14a),
a drive mechanism (46), wherein the drive mechanism (46) is arranged outside the vacuum chamber (14a) and is drivingly coupled to the drive unit (51),
wherein the drive unit (51) is connected to the sample holder (30) via a holder bar (50), the sample holder axis (50a) is designed as a central axis of the holder bar (50), the sample holder axis (50a) of the sample holder (30) is designed to be movable in a wobbling manner over a specified acute holder angle (B) relative to the longitudinal axis (40a) of the vacuum chamber (14a).

24. The device according to claim 23, wherein the holder angle (B) is predetermined to be a range of between (and including) 8° and 85° to the longitudinal axis (40a).

25. The device according to claim 23, wherein the holder angle (B) is 40°.

26. The device according to claim 23, wherein the sample holder axis (50a) and the holder bar (50) are mounted so as to be movable about the longitudinal axis (40a) of the vacuum chamber (14a), the longitudinal axis (40a) forming a wobble axis.

27. The device according to claim 23, wherein the sample holder receptacles (48) each have a mounting axis which are designed as longitudinal axes, and the mounting axes of the sample container receptacles (48) are aligned parallel to one another.

28. The device according to claim 27, wherein the sample holder axis (50a) is aligned parallel to the receiving axes of all sample container receptacles (48).

29. The device according to claim 23, further comprising
a drive shaft (40) cooperating with the drive unit (51),
wherein the drive shaft (40) generates a wobbling motion of the sample holder (30) about the longitudinal axis (40a) via the holder bar (50).

30. The device according to claim 29, wherein the drive shaft (40) cooperates with a gear unit (60, 62, 64, 66) for transmitting rotational movement.

31. The device according to claim 30, wherein the gear unit (60, 62, 32, 42) comprises a first gear wheel (42) connected to the drive shaft (40) and a second gear wheel (32) connected to the sample holder (30), with the first gear wheel (42) and the second gear wheel (32) meshing with one another in a drive-locking manner.

32. The device according to claim 31, wherein the holder bar (50) is connected to the second gear wheel (64).

33. The device according to claim 30, wherein the gear unit (60, 62, 64, 66) forms a step-up gear or a reduction gear.

34. The device according to claim 23, wherein the holder bar (50) is mounted and guided by a joint (52) that is spaced apart from the sample holder (30) and the drive unit (51).

35. The device according to claim 34, wherein the joint (52) is arranged in a joint holder (54) connected to the vacuum chamber (14a).

36. The device according to claim 23, wherein the drive mechanism (46) and the drive unit (51) are coupled to one another via a contactless coupling.

37. The device according to claim 23, further comprising
a device for heating the sample containers (12) and the samples,
wherein the device for heating the sample containers (12) and the samples are IR emitters directed onto the samples from above.

38. The device according to claim 23, further comprising
a set of different types of sample holders (30),
wherein each of the sample holders (30) is detachably connectable to the drive unit (51).

39. The device according to claim 23, further comprising
a set of different drive units (51),
wherein one drive unit (51) at a time can be releasably connected into the vacuum chamber (14a) for achieving different movements of the samples in the sample containers (12) during the treatment of samples and can be coupled to the drive mechanism (46).

40. A method for operating a device for treating samples in sample containers under vacuum according to claim 23, comprising
carrying out continuous movement of the inclined sample holder (30) about the longitudinal axis (40a) during treatment of the samples.

41. The method according to claim 40, wherein the movement is carried out as a wobbling motion of the sample holder (30) about the longitudinal axis (40a).

42. A method according to claim 40, wherein the drive unit (51) drives the sample holder (30) about the longitudinal axis (40a) at a wobble frequency of between 0.5 rpm and 150 rpm.

43. A method for removing liquids from samples in sample containers by evaporation by means of a device for treating samples in sample containers under vacuum, comprising
moving sample containers (12) in a way that samples flow continuously in one direction on an inner surface of the sample containers (12).

44. The method according to claim 43, comprising
operating a, and
carrying out continuous movement of an inclined sample holder (30) about a longitudinal axis (40a) during treatment of the samples,
wherein the device for treating samples in sample containers under vacuum comprises:
a vacuum chamber (14a), wherein the vacuum chamber (14a) is arranged in a housing (14) and interacts with a vacuum pump,
a cover (16), wherein the vacuum chamber (14a) is closed in a vacuum-tight manner and opened in order to load and unload the sample containers (12) via the cover (16),
the sample holder (30), wherein the sample holder (3) comprises a base surface and a plurality of sample container receptacles (48) for receiving the sample containers (12), a sample holder axis (50a) runs perpendicular to the base surface of the sample holder (30), a drive unit (51) is mounted in the vacuum chamber (14a) and drives the sample holder (30) about the longitudinal axis (40a) of the vacuum chamber (14a),
a drive mechanism (46), wherein the drive mechanism (46) is arranged outside the vacuum chamber (14a) and is drivingly coupled to the drive unit (51),
wherein the drive unit (51) is connected to the sample holder (30) via a holder bar (50), the sample holder axis (50a) is designed as a central axis of the holder bar (50), the sample holder axis (50a) of the sample holder (30) is designed to be movable in a wobbling manner over a specified acute holder angle (B) relative to the longitudinal axis (40a) of the vacuum chamber (14a).
